(19) United States
(12) Patent Application Publication
(10) Pub. No.: US 2010/0127021 A1
(43) Pub. Date: May 27, 2010

(54) Closure with lid with push-button actuation

(76) Inventors: Daniel G. Schantz, Muskego, WI (US); Kelly A. Smith, East Troy, WI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/313,979

(22) Filed: Nov. 26, 2008

(51) Int. Cl. B67D 7/06; B65D 47/00; B65D 35/38

(52) U.S. Cl. 222/505; 222/556; 222/498

(57) ABSTRACT

A dispensing closure system for use with an associated container includes a closure assembly having a closure base, and a lid moveably connected to the closure base. The present preferred embodiment of the closure includes a slider element mounted on an upper surface of the closure base for lateral movement between unactuated and actuated positions. The provision of camming surfaces on the slider element, which cooperate with the closure lid, permit convenient, push-button opening of the closure lid to facilitate convenient use by consumers.

### TECHNICAL FIELD

The present invention relates generally to container closures for dispensing a fluent substance, which may include personal care products or the like, and more particularly to a dispensing closure system especially suitable for a hand-held container, which includes a lid moveable between closed and open positions, with push-button actuation of the closure facilitating convenient, one-hand use by consumers.

### BACKGROUND OF THE INVENTION AND TECHNICAL PROBLEMS POSED BY THE PRIOR ART

Fluent materials, including liquids, creams, powders, etc., may be conventionally packaged in a container having a dispensing closure which includes a covering body that is provided over an open end of the container, and that defines one or more dispensing orifices communicating with the interior of the container. A cap or lid is typically provided secured to the covering body for occluding the one or more dispensing orifices when the container is not in use. The provision of an integral hinge maintains the moveable lid in association with the closure body, facilitating convenient use.

In order to further facilitate convenient use by consumers, the present closure system includes an arrangement for push-button operation for effecting opening movement of the lid thereof, with the arrangement desirably facilitating one-hand use by consumers, while at the same time facilitating assembly of the closure component to facilitate cost-effective manufacturing.

### SUMMARY OF THE INVENTION

The present invention is directed to a dispensing closure assembly, which includes an integrally hinged lid member for opening and closing of a dispensing orifice of the closure. Convenient push-button operation is provided by a laterally-movable slider element of the assembly. Mounting of the slider element on the associated closure base, i.e., “top-mounting” of the slider element, facilitates efficient, cost-effective manufacture and use of the present closure arrangement. Camming surfaces of the slider element are configured to provide the desired degree of vertical opening movement of the closure lid attendant to horizontal movement of the slider element.

In accordance with the present invention, a dispensing closure system for a container having an opening includes a closure base for extending from the container at the opening thereof. The container base includes a dispensing orifice for communicating with the interior of the container.

The present closure system further includes a lid for movement between a closed position on top of the base to occlude the dispensing orifice, and an open position, away from the dispensing orifice, to permit dispensing of a substance from within the container. The system includes a hinge for moveably connecting the lid to the closure base, with these components of the present system preferably being integrally formed as a one-piece component from suitable polymeric material.

In accordance with the present invention, the present closure system further includes an element, which is generally ring-shaped in a preferred embodiment. The slider element is mounted on an upper surface of the closure base for generally lateral movement with respect thereto from an unactuated position, to an actuated position. The slider element includes a pair of camming surfaces engageable with the lid in the closed position thereof, when the slider element is in its unactuated position. The slider element is moveable generally laterally of the closure base from the unactuated position toward the actuated position thereof, to thereby cause the camming surfaces to act at generally opposite sides of the dispensing orifice, to thereby urge the lid upwardly out of its closed position toward the open position thereof. By this action, dispensing of the fluent substance within the container through the orifice is permitted.

By this arrangement of camming surfaces, at generally laterally opposite sides of the dispensing orifice, forces generated by actuation of the slider element are generally concentrated in the region of the orifice, and desirably act in close association with that portion of the lid which occludes the orifice. The desired degree of vertical movement of the closure lid is thus created attendant to horizontal of lateral movement of the slider element The typical interference or snap-fit between the lid and the closure base at the dispensing orifice is thus effectively and conveniently disengaged by lateral movement of the slider element.

In accordance with the preferred embodiment, the slider element includes a button portion configured for manipulation by consumers to move the slider element laterally of the closure base from the unactuated to actuated position thereof. Convenient, one-hand manipulation and opening of the closure system is thus facilitated.

In order to further facilitate opening movement of the closure lid attendant to lateral movement of the slider element, the slider element further preferably includes a pusher portion, positioned distally of the button portion, for engagement with the lid. By this arrangement, lateral movement of the slider element from its unactuated position toward its actuated position moves the pusher portion into engagement with the lid, to thereby urge the lid toward its open position.

In one illustrated embodiment of the present invention, the camming surfaces of the slider element extend angularly from respective opposite sides of the button portion. In other disclosed embodiments, the camming surfaces have a generally partially frustoconical configuration. In one of these embodiments, the button portion of the slider element is contiguous with the camming surfaces, and also has a generally partially frustoconical configuration. In an alternate embodiment, the button portion extends generally laterally between the partially frustoconical camming surfaces.

In the preferred form, the pusher portion of the slider element defines an inwardly facing stop surface, engageable with the closure base, to thereby limit movement of the slider element from its actuated position to its unactuated position.

In two embodiments, the lid of the closure system defines an opening within which the button portion of the slider is complementarily positioned when the slider element is in its unactuated position, and the lid is in its closed position.

By these various arrangements, an aesthetically pleasing closure system construction is provided, while at the same time facilitating convenient one-hand, push-button actuation by consumers.

Other features and advantages of the present invention will become readily apparent from the following detailed description, the accompanying drawings, and the appended claims.

### BRIEF DESCRIPTION OF THE DRAWINGS

FIG. 1 is an isometric view of a dispensing closure configured for push-button actuation configured in accordance with the present invention;

FIG. 2 is an isometric view of the closure illustrated in FIG. 1, with the lid thereof shown in an open position;

FIG. 3 is a cross-sectional view of the dispensing closure shown in FIG. 1;

FIG. 4 is an isometric view of an alternate embodiment of the present dispensing closure having push-button actuation;

FIG. 5 is an isometric view of the closure shown in FIG. 4, illustrating the lid thereof in an open position;

FIG. 6 is a cross-sectional view of the dispensing closure shown in FIG. 4;

FIG. 7 is an isometric view of a further embodiment of a dispensing closure having push-button actuation;

FIG. 8 is an isometric view of the dispensing closure shown in FIG. 7, with the lid thereof in an open position; and

FIG. 9 is a cross-sectional view of the closure shown in FIG. 7.

### DETAILED DESCRIPTION

While this invention is susceptible of embodiment in many different forms, the specification and the accompanying drawings disclose specific embodiments of the invention. The invention is not intended to be limited to the specific embodiments so described. However, the scope of the invention is pointed out in the appended claims.

For ease of description, many of the figures illustrated in the invention show the dispensing closure system as including a separate, removable, dispensing closure in the typical configuration that the closure would have at the top of an associated container when the container is stored upright on its base, and terms such as upper, lower, horizontal, etc. are used with reference to this position. It will be understood, however, that the closure system of this invention may be manufactured, stored, transported, used, and sold in an orientation other than the orientation described.

The dispensing closure system of this invention is suitable for use with a variety of conventional or special fluent substance dispensing systems, including packages, articles, and other dispensing equipment or apparatus, the details of which, although not fully illustrated or described, would be apparent to those having skill in the art and an understanding of such fluent substance dispensing systems. Such a fluent substance dispensing system, or portion thereof, with which the inventive dispensing closure system cooperates is hereinafter simply referred to as a “container”. Particulars of such a container are not intended to limit the present invention. It will be understood by those of ordinary skill in the art that novel and non-obvious inventive aspects are embodied in the described exemplary dispensing closure system alone.

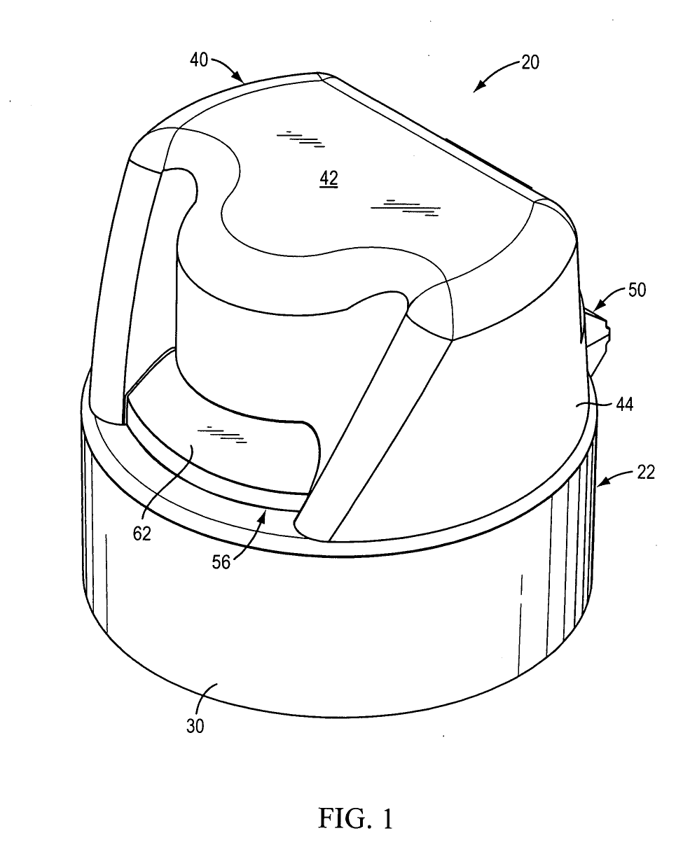

With reference to FIGS. 1-3, therein is illustrated a first embodiment of the present closure dispensing system, comprising an assembly of components as will hereinafter be described, with reference to closure 20 of the present invention. Closure 20 includes a closure base 22 which may be configured as a separate component configured for attachment to an associated container (not illustrated). To this end, the closure base 22 includes a generally horizontal closure deck 24, and a generally upstanding closure spout 26 extending upwardly from the closure deck 24, with the closure spout defining a dispensing orifice 28 through which a fluent substance in the associated container can be selectively dispensed.

The closure 20 can be used to dispense substances, including, but not limited to liquids, suspensions, mixtures, etc. (such as, for example, a personal care product, an industrial or household cleaning product, or other compositions of matter, e.g., compositions for use in activities involving manufacturing, commercial or household maintenance, construction, agricultural, medical treatment, military operations, etc.).

The associated container with which the closure 20 may be used would typically be a squeezable container having a flexible wall or walls which can be grasped by the user and squeezed or compressed to increase the internal pressure within the container so as to force the product out of the container and through the opened closure. Such a flexible container wall typically has sufficient, inherent resiliency so that when the squeezing forces are removed, the container wall returns to its normal, unstressed shape. Such a squeezable container is preferred in many applications, but may not be necessary or preferred in other applications. For example, in some applications, it may be desirable to employ a generally rigid container, and to pressurize the container interior at selected times with a piston or other pressurizing system, or to reduce the exterior ambient pressure around the exterior of the closure so as to suck the material out through the open closure.

It is presently contemplated that many applications employing the closure 20 will be conveniently realized by molding at least some of the components or portions of the closure 20 from suitable thermoplastic material or materials. In the illustrated embodiments, the components of the closure can be molded from a suitable thermoplastic material, such as, but not limited to, polypropylene. The closure components may be molded from different materials. The materials may have the same or different colors and textures.

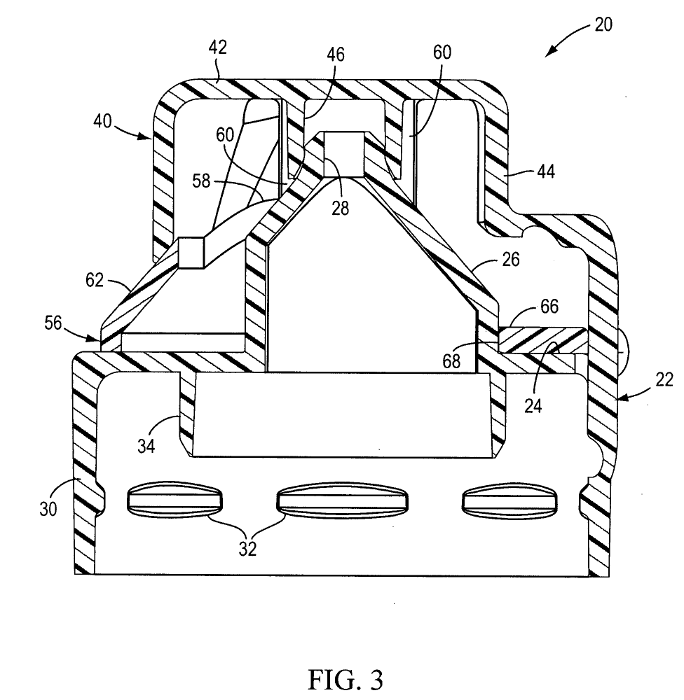

Securement of the closure 20 to an associated container can be effected by the provision of a depending skirt 30 of the closure base, which extends downwardly from the closure deck 24. The closure skirt may be provided with one or more suitable retention elements, such as retention beads 32 (FIG. 3), which can be configured for cooperation with a suitable external retention element of an associated container. In the illustrated embodiment, the closure base includes a hollow, generally cylindrical, internal, annular, plug seal 34, depending from the deck 24 inwardly of the skirt 30, for cooperative engagement with the mouth of an associated container.

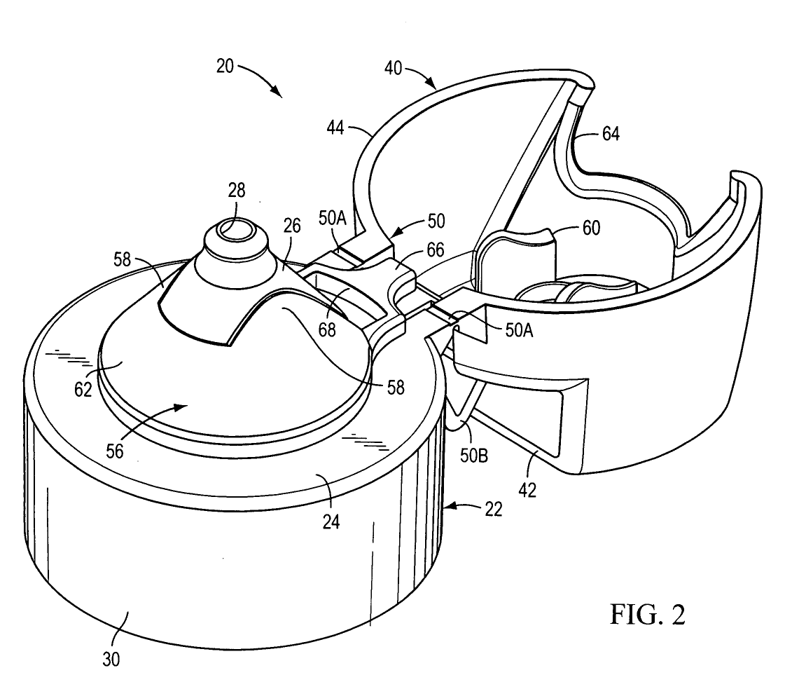

In accordance with the present invention, the closure 20 includes a moveable lid 40 moveably mounted on the closure base 22 for movement toward and away from closure deck 24, with the lid 40 configured for occluding the dispensing orifice 28 of the closure base. The specific configuration of the closure lid can vary in keeping with the principles disclosed herein, with the lid generally including a top wall portion 42 (FIG. 3), and a partially annular, depending skirt portion 44. The lid 40 includes a sealing collar 46 depending generally downwardly from the interior of top wall portion 42 for sealing, cooperative engagement with the spout 26 of closure base 22, thereby occluding the dispensing orifice 28 when the lid is in its closed position, such as illustrated in FIGS. 1 and 3. In the open position of the lid, illustrated in FIG. 2, the lid 40 is moved out of sealing cooperation with the closure base 22, to thereby permit dispensing of substances from the associated container through the dispensing orifice 28.

Movement of the lid 40 between closed and open positions with respect to the closure base 22 is facilitated by the provision of a hinge 50 (FIG. 1) connecting the lid 40 to the closure base 22. In a presently preferred embodiment, the hinge includes a pair of spaced-apart film hinges 50A (FIG. 2), and offset connecting spring link 50B, provided on the lid 40. This arrangement provides a snap-action hinge structure which permits the lid 40 to be moved between open and closed positions as the link 50B deforms elastically through a dead center position at which the link 50B is maximally deformed. On either side of the top of the dead center position, the elastic deformation of the link 50B is at least partially reduced, and the lid 40 is thus urged to a stable position at the end of its travel range on that side of the dead center position. Thus, when the lid 40 is in its closed position (FIG. 1) it is self-maintained in the closed position. On the other hand, when the lid 40 is in the open position (FIG. 2), it is self-maintained in that position, to thereby accommodate dispensing of contents without the user having to maintain the lid in an out-of-the-way disposition.

In accordance with the present invention, the present closure is configured for convenient, push-button operation by the provision of a slider element 56 mounted on an upper surface of the closure base 22 for reciprocable, generally lateral sliding movement with respect thereto from an unactuated position (FIGS. 1 and 3) to an actuated position (FIG. 2). As will be observed, the slider element 56 has a generally ring-shaped configuration, and fits on closure deck 24 generally about the closure spout 26 of the closure base 22. Disposition of the slider element on the upper surface of the closure base, sometimes referred to as “top-mounting”, facilitates convenient and cost-effective assembly of the present closure system, thereby facilitating cost-effective use with associated containers. Top-mounting desirably precludes the need to provide a double-wall structure beneath the closure deck, as would ordinarily be required if the slider element were “bottom-mounted” beneath the closure deck. One or more suitable snap-fit components (not shown) can be provided on the slider element 56 and/or the closure base 22 for retention of the slider element on the base, while facilitating the desired lateral movement thereof with respect to the closure base.

In accordance with the present invention, the slider element 56 includes a pair of camming surfaces positioned to act at generally laterally opposite sides of the dispensing orifice 28, to thereby facilitate convenient disengagement of the sealing collar 46 of the lid 40 from sealing cooperation with the closure spout 26. In this illustrated embodiment, the slider element 56 includes a pair of camming surfaces 58 which are positioned at generally opposite sides of the dispensing orifice 28, generally adjacent to respective opposite sides of the closure spout 26. The camming surfaces 58 are configured to respectively engage and coact with a pair of camming elements 60 (FIGS. 2 and 3) provided on the interior surface of the top wall portion 42 of closure lid 40.

Convenient manipulation of the slider element 56 is facilitated by the provision of button portion 62, which extends generally laterally between the camming surfaces 58. In this illustrated embodiment, the camming surfaces 58, and the button portion 62, are contiguous, and each have a generally partially frustoconical configuration, which partially frustoconical configurations can be provided in a generally complementary form to the upper portion of closure spout 26 (see FIG. 2). To facilitate manipulation of the slider element when the lid 40 is in its closed position, button portion 62 is generally exposed when the lid is in its closed position. In the illustrated embodiment, the lid 40 defines an opening 64 (FIG. 2) within which the button portion 62 is complementarily positioned when the slider element is in its unactuated position, and the lid 40 is in its closed position.

In order to enhance reliable movement of the lid from its closed position to its open position, through the center position of hinge 50, attendant to push-button actuation of the slider element 56, the slider element is further preferably provided with a pusher portion 66 (FIG. 2), positioned distally of button portion 62. Pusher portion 66 is engageable with deformable link 50B of the lid 40, when the lid is in its closed position (FIG. 3), and the slider element is in its initial, unactuated position. By this arrangement, lateral movement of the slider element 56 with respect to the closure base urges pusher portion 66 against deformable link 50B, thus acting in cooperation with camming surfaces 58 to move the lid from its closed position, and to its fully open position.

In the preferred form, the pusher portion 66 defines an inwardly facing stop surface 68 (FIG. 2), which is engageable with the rear lower portion of the spout 26 of the closure base to thereby limit movement of the slider element from its actuated, initial position (FIG. 3) to its unactuated position, attendant to closing manipulation of the lid by the consumer, with link 50B acting against pusher portion 66 to move the slider element laterally of the closure base forwardly toward the front of the closure. Thus, opening movement of the lid 40 is effected by push-button actuation of slider element 56, with closing manipulation of the lid 40 acting on pusher portion 66 to return the slider element 56 to its initial position.

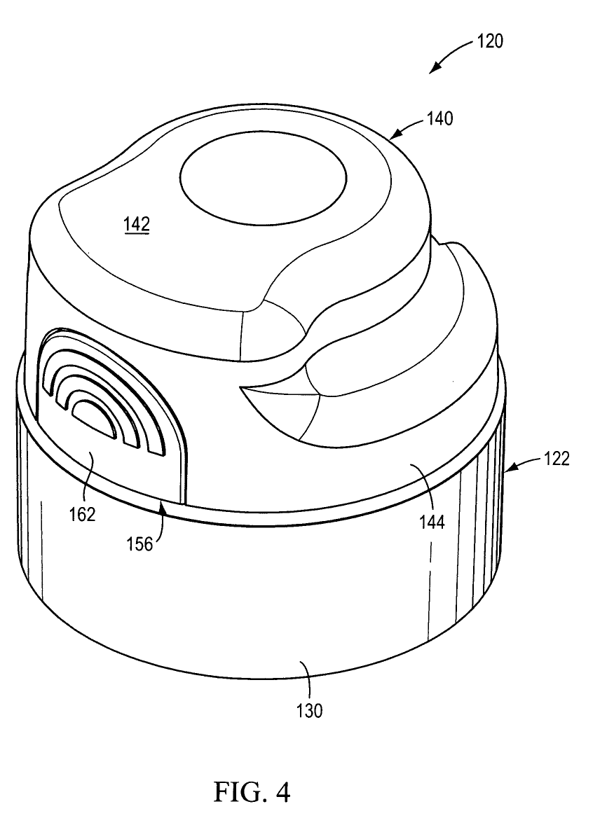

With reference now to FIGS. 4-6, therein is illustrated an alternate embodiment of the present dispensing closure, with elements corresponding to the previously described embodiment designated by like reference numerals in the 100-series.

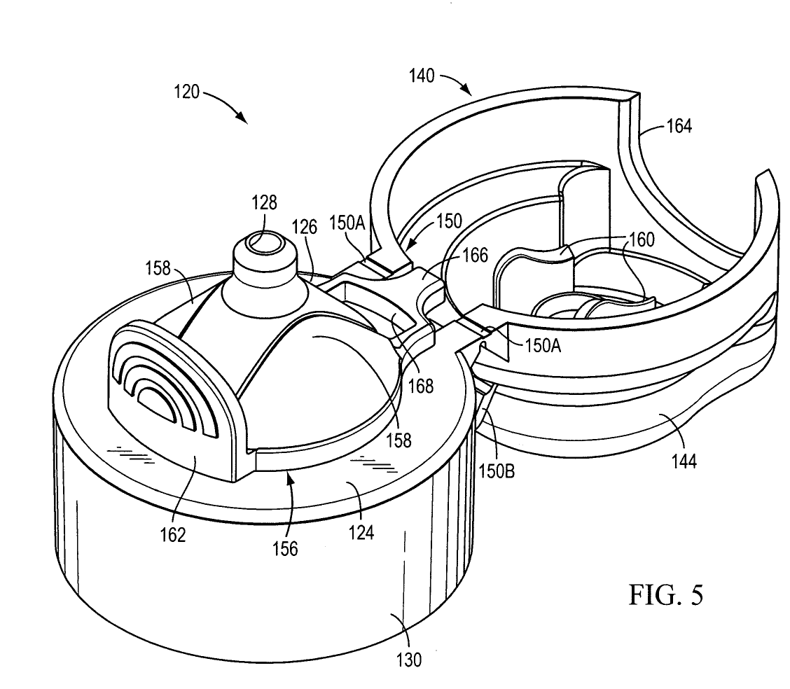

Thus, FIGS. 4-6 illustrate a dispensing closure 120 including a closure base 122 configured for attachment to an associated container. The closure base 122 includes a generally horizontal deck 124 (FIG. 5), which defines a generally upstanding closure spout 126. The closure spout defines a dispensing orifice 128 through which a fluent substance from the associated container can be dispensed.

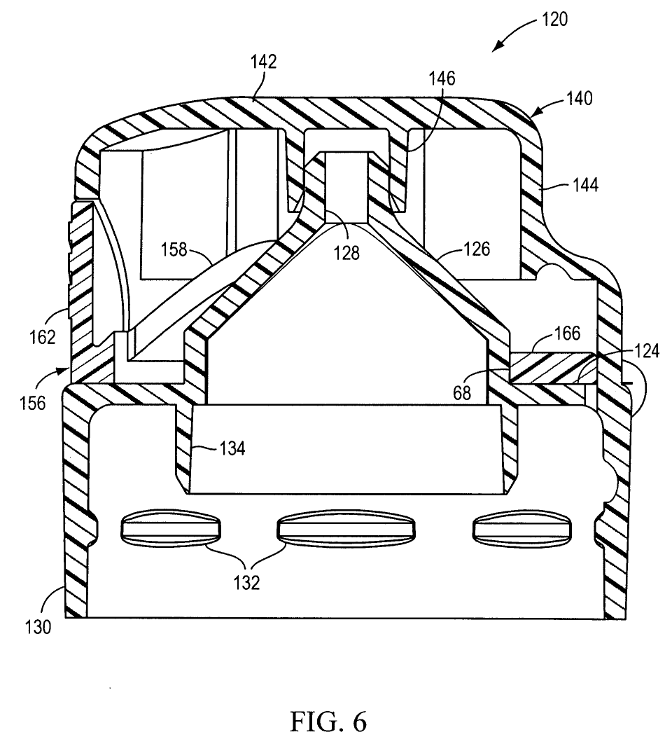

The closure base includes an annular skirt 130 which depends from the closure deck 124 of the closure base, with the skirt provided with at least one suitable retention element 132 (FIG. 6), configured for cooperative engagement with a suitable external retention element of an associated container. As in the previous embodiment, the closure base 122 of closure 120 includes a hollow, generally cylindrical internal, annular, plug seal 134, which can be configured for cooperative engagement with the mouth of an associated container.

The closure 120 further includes a moveable lid 140, configured for movement away from and toward closure base 122, between open and closed positions, respectively. The lid 140 includes a top wall portion 142 (FIG. 6), and a skirt portion 144 depending from the top wall portion 142. An internal sealing collar 146 (FIG. 6) depends from the interior of the top wall portion 142, for sealing, cooperative engagement with the closure spout 126, thereby occluding the dispensing orifice 128 of the closure base.

As in the previous embodiment, a hinge 150 (FIG. 5) is provided for moveably connecting the lid 140 to the closure base 122, with a pair of hinges 150A provided on respective opposite sides of a resiliently deformable link 150B of the lid 140.

In accordance with the present invention, push-button actuation of the moveable lid 140 is effected by the provision of a laterally moveable, top-mounted slider element 156 (FIG. 5) mounted on an upper surface of the closure deck 124 of closure base 122. The slider element 156 is configured for reciprocable, generally lateral sliding movement with respect to the closure base, between an unactuated position (FIGS. 4 and 6), and an actuated position (FIG. 5), with lateral movement of the slider element effecting movement of the associated closure lid 140 from its closed position (FIGS. 4 and 6) to its open position (FIG. 5).

To this end, the slider element 156 is generally ring-shaped, and fits about the closure spout 126 of the closure base 122, and includes a pair of camming surfaces 158 positioned on respective opposite sides of the closure spout 126. By this arrangement, the camming surfaces 158 are positioned to act generally at laterally opposite sides of the dispensing orifice 128 to urge the associated lid 140 out of its closed position toward its open position. This permits dispensing of a fluent substance from within the container through the dispensing orifice.

In order to provide the desired cooperate engagement between camming surfaces 158 and the closure lid 140, the closure lid preferably includes a pair of camming elements 160 (FIGS. 5 and 6) positioned on the interior of top wall portion 142 for respective cooperative engagement with the camming surfaces 158 of the slider element 156. As in the previous embodiment, the camming surfaces 158 have a generally partially frustoconical configuration, which promotes the desired camming cooperation with camming elements 160 provided on the closure lid 140.

Convenient manipulation of the slider element 156 is facilitated by the provision of button portion 162 which extends laterally generally between the camming surfaces 158. In this embodiment, the closure lid 140 defines an opening 164 within which the button portion 162 is complementarily positioned when the slider element 156 is in its unactuated position, and the lid 140 is in its closed position, as illustrated in FIGS. 4 and 6.

In order to urge the closure lid 140 to its fully open position after initial lateral movement of slider element 156 urges camming surfaces 158 into cooperation with camming elements 160, the slider element 156 preferably includes a pusher portion 156 positioned distally of button portion 162. Pusher portion 156 is configured for cooperative engagement with the elastically deformable link 150B of the lid 140, and acts to move the lid to its fully open position after disengagement of sealing collar 146 from the closure spout 126 of closure base 122.

Manipulation of closure lid 140 from its open position toward its closed position, for closing the dispensing orifice 128, causes the deformable link 150B to engage the pusher portion 166 of the slider element thereby laterally pushing the slider element from its actuated position back to its initial unactuated position. The pusher portion 166 preferably includes an inwardly facing stop surface 168 for cooperative engagement with the lower portion of the spout 126 of the closure base 122 to thereby limit movement of the slider element from its actuated position to its unactuated, initial position (FIG. 6).

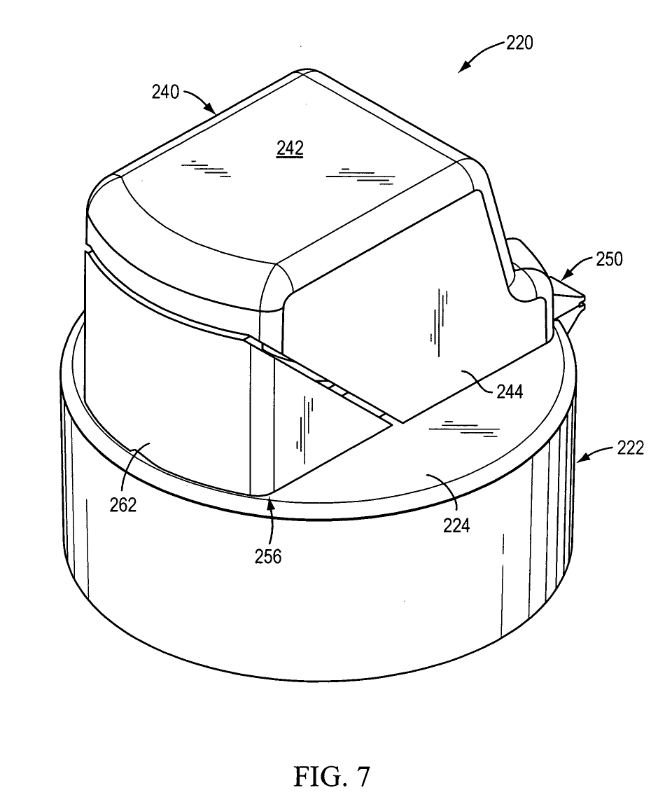

A further embodiment of the present dispensing closure system is illustrated in FIGS. 7-9, with features of this embodiment corresponding to the previously described embodiments designated by like reference numerals in the 200-series.

Accordingly, dispensing closure 220 includes a closure base 222 configured for securement to an associated container. The closure base 222 includes a generally horizontal closure deck 224, with a closure spout 226 extending generally upwardly from the closure deck. The closure spout 226 defines a dispensing orifice 228 through which a fluent substance from the associated container can flow during dispensing operation of the closure.

The closure base 222 further includes a generally annular skirt 230 which depends from the closure deck 224. As illustrated, the skirt 230 may include at least one retention element 232, such as for cooperative engagement with an external retention element of an associated container. The closure base 222 includes an internal plug seal 234 having a hollow, generally cylindrical configuration, positioned inwardly of the skirt 230, for cooperative engagement with the mouth of an associated container.

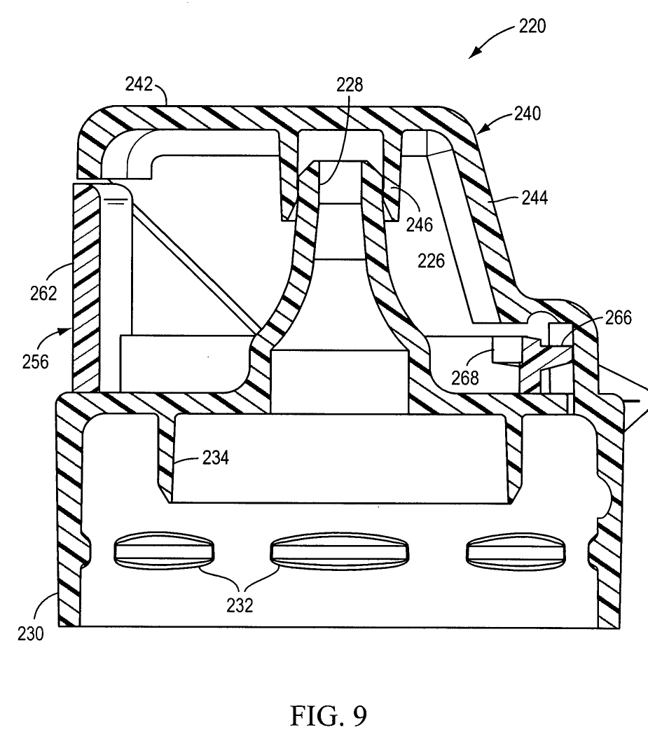

In accordance with the present invention, the dispensing closure 220 includes a lid 240 which is moveable with respect to the closure base 222 between open and closed positions, by movement away from and toward the closure deck 224 of the closure base. The closure lid 240 includes a top wall portion 242 (FIG. 7), and a skirt portion 244 depending from the top wall portion 242. A sealing collar 246 (FIG. 9) provided on the interior surface of the top wall portion 242 is configured for cooperative sealing engagement with the closure spout 226 of the closure base, to thereby occlude and seal the dispensing orifice 228 of the closure base. A pair of hinges 250A of hinge 250 moveably attach the lid 240 to the closure base 222, with a resiliently deformable link 250B of the lid 240 acting to bias the lid away from the opposite side of its dead center position.

In accordance with the present invention, the dispensing closure 220 includes a laterally moveable, top-mounted slider element 256, positioned on top of closure deck 224 for generally lateral sliding movement with respect to the closure base 222. The slider element 256 is generally ring-shaped, and includes a pair of camming surfaces 258 positioned to act generally at laterally opposite sides of the dispensing orifice 228 to urge the lid 240 out of its closed position toward its open position. The slider element 256 includes a button portion 262 which extends generally between the camming surfaces 258. In this embodiment, the camming surfaces 258 extend angularly from respective opposite sides of the button portion 262.

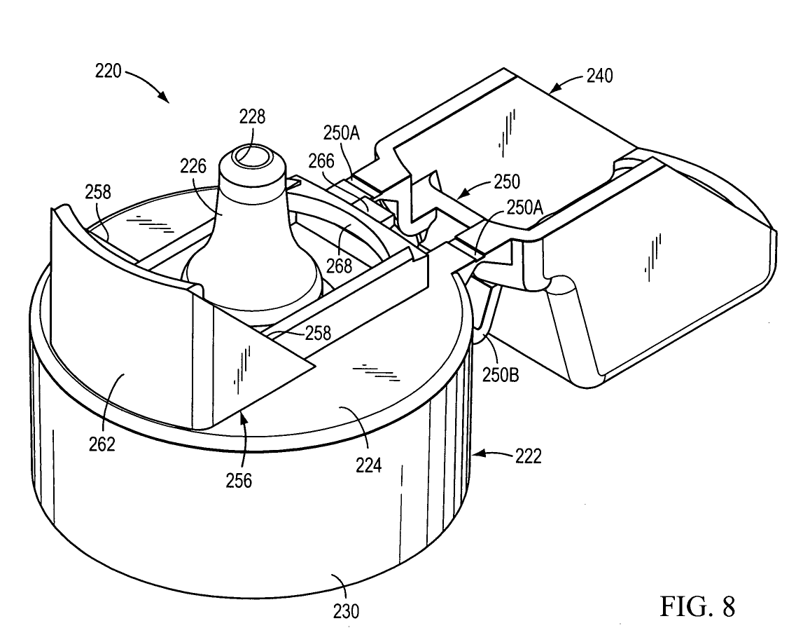

In order to promote opening movement of the lid 240 to its fully open position, the slider element 256 preferably includes a pusher portion 266 (FIGS. 8 and 9), positioned distally of button portion 262. Pusher portion 266 engages and coacts with the deformable link 250B of the lid 240 for urging the lid to its fully open position, after disengagement of sealing collar 246 from closure spout 226 of the closure base 222.

During manipulation of the lid 240 from its open position toward its closed position, the link 250B of the lid coacts with the pusher portion 266 to laterally move the slider element 256 from its actuated position to its unactuated position. Attendant to this movement, a stop surface 268 of the pusher portion is engageable with the lower portion of the spout 226 on the closure base 222 to limit movement of the slider element toward its unactuated position.

As will be appreciated, from the description of the embodiments of the present invention, versatile and cost-effective use of the present closure system is promoted. As noted, top-mounting of the slider element on the associated closure base facilitates assembly. A suitable snap-fit arrangement can be provided whereby the slider element can be snapped onto, and maintained on, the closure base attendant to lateral actuation. Such an optional snap-fit arrangement is not illustrated and is not a necessary element of the present invention.

By virtue of top-mounting of the slider element, the present closure can be configured to include a single wall or skirt depending from the deck portion of the closure base, thus providing a design requiring less polymeric material. The skirt of the closure can have threads or retention beads to facilitate assembly with an associated container, with a single wall closure structure thus being possible.

The configuration of the slider element by which the button portion is exposed and visible facilitates convenient, one-hand manipulation by consumers. Application of force to the button portion by a consumer causes the slider element to travel in a lateral or horizontal motion along the deck of the closure base, thereby actuating the cam elements of the closure lid, preferably located generally near the center of this component, at laterally opposite sides of the dispensing orifice of the closure. Engagement of the camming surfaces with the camming elements acts to disengage the sealing system of the closure from the dispensing orifice.

Once the sealing system is disengaged, the slider element continues to press on the elastically deformable link of the hinge of the closure. In this fashion, the hinge bias eventually takes over and the cover opens completely. If desired, friction ribs (not illustrated) can be provided on the slider element to keep the slider element in its actuated position. Additionally, a return spring (not illustrated), such as by a resiliently deformable integral spring element on the slider element, can be added to urge the slider element to its initial, unactuated position, while the associated lid remains in its open position. Alternatively, if such a return spring is not employed, then the slider element is maintained in its actuated position while the lid is in its open position, and subsequent closing movement of the lid by the consumer forces the slider element back into its pre-actuated or unactuated position.

As will be appreciated from the above description, disposition of the camming surfaces of the slider element in a close, operative association with the sealing arrangement for the dispensing orifice facilitates direction of the opening force, provided by lateral movement of the slider element, upwardly at the lid where the lid sealingly engages the dispensing orifice. Convenient and effective opening movement of the lid is thus provided. As will be appreciated, consumers may conveniently grasp the associated container with one hand, manipulate the button portion of the slider element to open the closure lid with the thumb or a finger of that hand, and thereafter conveniently dispense the container contents. Closing of the lid can also be conveniently effected.

It will be readily observed from the foregoing detailed description of the invention and from the illustrations thereof that numerous other variations and modifications may be effected without departing from the true spirit and scope of the novel concepts or principles of this invention.

1. A dispensing closure system for a container that has an opening to the container interior where a fluent substance may be stored, said dispensing closure system comprising:
(A) a closure base for extending from said container at said container opening, said closure base having a dispensing orifice for communicating with the container interior;
(B) a lid for movement between: (1) a closed position on top of said base to occlude said dispensing orifice, and (2) an open position away from said dispensing orifice to permit the dispensing of a substance from said container;
(C) a hinge connecting said lid with said closure base; and
(D) a slider element mounted on an upper surface of said closure base for generally lateral movement with respect thereto from a unactuated position to an actuated position,
said slider element including a pair of camming surfaces engageable with said lid in the closed position thereof when said sliding element is in said unactuated position, said slider element being movable generally laterally of said closure base from said unactuated position toward said actuated position to cause said camming surfaces to act at generally laterally opposite sides of said dispensing orifice to urge said lid out of said closed position toward said open position, to thereby permit dispensing of the fluent substance within said container through said dispensing orifice.

2. The closure system in accordance with claim 1 for use with a container that has an annular top end defining (1) an opening, and (2) an external, male thread around said opening, and in which:
said closure system is a dispensing closure that is separate from, but releasably attachable to, said container around said container opening;
said closure base includes (1) a deck through which said dispensing orifice can communicate with the container interior, and (2) a skirt depending from said deck; and
said closure base has a hollow, generally cylindrical, internal plug seal depending from said deck inwardly of said skirt.

3. The closure system in accordance with claim 1, wherein:
said slider element includes a button portion configured for manipulation to move said slider element laterally of said closure base from said unactuated positioned to said actuated position.

4. The closure system in accordance with claim 3, wherein:
said lid defines an opening within which said button portion of said slider element is positioned when said slider element is in said unactuated position and said lid is in said closed position.

5. The closure system in accordance with claim 3, wherein:
said button portion of said slider element and said camming surfaces are contiguous and have a generally partially frustoconical configuration.

6. The closure system in accordance with claim 1, wherein:
said pair of camming surfaces has a generally partially frustoconical configuration, said slider element including a button portion configured for manipulation to move said slider element laterally of said closure base from said unactuated position to said actuated position, said button portion extending laterally between said camming surfaces.

7. The closure system in accordance with claim 1, wherein:
said slider element includes a button portion configured for manipulation to move said slider element laterally of said closure base from said unactuated position to said actuated position, said camming surfaces extending angularly from respective opposite sides of said button portion.

8. The closure system in accordance with claim 4, wherein:
said slider element includes a distal pusher portion, positioned distally of said button portion, for engagement with said lid so that lateral movement of said slider element from said unactuated position to said actuated position moves said pusher portion into engagement with said lid to urge said lid toward said open position.

9. The closure system in accordance with claim 1, wherein:
said slider element includes a button portion configured for manipulation to move said slider element laterally of said closure base from said unactuated position to said actuated position, and a distal pusher portion, positioned distally of said button portion, for engagement with said lid so that lateral movement of said slider element from said unactuated position to said actuated position moves said pusher portion into engagement with said lid to urge said lid toward said open position, said pusher portion defining an inwardly facing stop surface engageable with said closure base to limit movement of said slider element from said actuated position to said unactuated position.

10. A dispensing closure system for a container within which a fluent substance may be stored, said container having an annular top end defining (1) an opening, and (2) an external retention element around said opening, said closure system being attachable to said container around said container opening, said dispensing closure system comprising:
(A) a closure base for extending from said container at said container opening, said closure base having (1) a dispensing orifice for communicating with the container interior, (2) a deck through which said dispensing orifice communicates with the container interior, and (3) a skirt depending from said deck, said skirt including at least one retention element for cooperation with said external retention element of said container;
(B) a lid for movement between: (1) a closed position on top of said base to occlude said dispensing orifice, and (2) an open position away from said dispensing orifice to permit the dispensing of a substance from said container;
(C) a hinge connecting said lid with said closure base; and
(D) a slider element having a generally ring-shaped configuration mounted on an upper surface of said closure base for generally lateral movement with respect thereto from a unactuated position to an actuated position,
said slider element including a pair of camming surfaces engageable with said lid in the closed position thereof when said sliding element is moved out of said unactuated position, so that lateral movement of said slider element relative to said closure base from said unactuated position toward said actuated position causes said camming surfaces to urge said lid out of said closed position toward said open position, and to thereby permit dispensing of the fluent substance within said container through said dispensing orifice,
said slider element including a distal pusher portion for engagement with said lid so that lateral movement of said sliding element from said unactuated position to said actuated position moves said pusher portion into engagement with said lid to urge said lid toward said open position.

11. The closure system in accordance with claim 10, wherein:
slider element includes a button portion configured for manipulation to move said slider element laterally of said closure base from said unactuated position to said actuated position, said button portion extending generally between said pair camming surfaces.

12. The closure system in accordance with claim 11, wherein:
said lid defines an opening within which said button portion of said slider element is complementarily positioned when said slider element is in said unactuated position and said lid is in said closed position.

13. The closure system in accordance with claim 12, wherein:
said button portion of said slider element and said camming surfaces are contiguous and each have a generally partially frustoconical configuration.

14. The closure system in accordance with claim 12, wherein:
said pair of camming surfaces have a generally partially frustoconical configuration.

15. The closure system in accordance with claim 10, wherein:
said slider element includes a button portion configured for manipulation to move said slider element laterally of said closure base from said unactuated positioned to said actuated position, said camming surfaces extending angularly from respective opposite sides of said button portion.

16. The closure system in accordance with claim 11, wherein:
said closure base has a spout extending upwardly from said deck to define said dispensing orifice; and
said closure base has a hollow, generally cylindrical, internal, annular plug seal depending from said deck inwardly of said skirt.
